(19) United States
(12) Patent Application Publication
(10) Pub. No.: US 2007/0235624 A1
(43) Pub. Date: Oct. 11, 2007

(54) Bracket for fixing compressor

(75) Inventor: Sung Tae Lee, Gwangju (KR)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: SAMSUNG ELECTRONICS CO., LTD

(21) Appl. No.: 11/731,104

(22) Filed: Mar. 30, 2007

(30) Foreign Application Priority Data
Apr. 5, 2006 (KR) 2006-31036

(51) Int. Cl. F16M 7/00

(52) U.S. Cl. 248/674

(57) ABSTRACT

Disclosed is a bracket for fixing a compressor capable of reducing vibration generated due to resonance occurring when a specific frequency generated from the compressor matches with a natural frequency of the bracket for fixing the compressor. The bracket for fixing the compressor includes a body section extending in one direction and a folding section coupled so as to change the natural frequency of the bracket. The bracket for fixing the compressor includes a body section extending in one direction and a weight coupled to the body section so as to reduce displacement when the bracket is vibrated.

### CROSS-REFERENCE TO RELATED APPLICATION

This application claims the benefit under 35 U.S.C. §119 of Korean Patent Application No. 2006-31036, filed on Apr. 5, 2006 in the Korean Intellectual Property Office, the disclosure of which is incorporated herein by reference.

### BACKGROUND OF THE INVENTION

1. Field of the invention

The present disclosure relates to a bracket for fixing a compressor, and more particularly to a bracket for fixing a compressor, capable of reducing a vibration generated due to resonance by changing a natural frequency of the bracket for fixing the compressor relative to a specific frequency which is generated from the compressor or reducing a displacement when the bracket is vibrated.

2. Description of the Prior Art

As shown in FIG. 1, a conventional compressor 1 is equipment which intakes a coolant into a closed space, and then compresses and discharges the coolant, and includes a compressing unit 2 compressing the coolant, a driving unit 3 which drives the compressing unit 2 and a closed container 5 which protects internal structure and forms an external appearance of the compressor 1.

When the compressor 1 is used in a product such a refrigerator and an air conditioner, a lower portion of the compressor 1 is fixed by a bracket 10, and the bracket 10 is fixed to a base 12 while being supported by a vibration-resistant member 11.

When such a compressor 1 is operated, excessive noise and vibration occur when the compressor 1 receives a driving force from the driving unit 3, the compressing unit 2 is operated by the driving force, a fluid is compressed, and the compressed fluid is discharged. Such noise and vibration can be removed to some extent by means of a sound insulation member and a vibration-resistant member (not shown) which are separately installed in the compressor.

However, vibration generated from the internal structure of the compressor 1 serves as a vibration source and is transferred to the bracket 10 for fixing the closed container 5 and the base 12. At this time, if a specific frequency (a high level frequency) generated from the compressor 1 matches with a natural frequency of the bracket 10, resonance may occur. In addition, if the frequency caused by such resonance matches with a frequency of the base 12, greater vibration occurs, thereby causing vibration to the product equipped with the compressor 1 or generating abnormal noise.

### SUMMARY OF THE INVENTION

The present disclosure has been made to solve the above-mentioned problems occurring in the prior art, and an object of the present disclosure is to provide a bracket capable of reducing vibration, which is derived from a compressor and is applied to a product, by changing a natural frequency of the bracket relative to a specific frequency generated in the compressor or reducing a displacement of the bracket when the bracket vibrates.

In order to accomplish the above object, according to an aspect of the present disclosure, there is provided a bracket for fixing a compressor comprising a body section extending in one direction and a folding section coupled to the body section while being bent relative to the body section so as to change a natural frequency of the bracket.

The folding section includes a plurality of embosses protruding from a flat surface forming the folding section, and the embosses are welded such that the body section is coupled with the folding section.

The folding section protrudes from a middle portion of the body section in a width direction of the body section so as to be folded on the middle portion of the body section.

The folding section protrudes from both sides of the body section in a length direction of the body section so as to be folded on both sides of the body section.

The body section is formed with a first coupling hole, into which a vibration-resistant member supporting the bracket is coupled, and the folding section is formed with a second coupling hole, which is symmetrical to the first coupling hole about a bending section at which the folding section is bent.

The bracket of the present disclosure can have a folding section that has a length identical to a length of the body section and protrudes in a width direction of the body section so as to be folded on the body section.

The bracket of the present disclosure can have a body section that is formed with a coupling hole into which a vibration-resistant member supporting the bracket is coupled, and a width of the folding section is smaller than a distance between the bending section at which the folding section is bent and the coupling hole so as to prevent the folding section from blocking the coupling hole.

According to another aspect of the present disclosure, there is provided a bracket for fixing a compressing comprising a body section extending in one direction and a weight coupled to the body section so as to reduce displacement when the bracket vibrates.

The weight includes a leaf spring having a corrugated shape.

The bracket of the present disclosure can have a weight that includes a fixing end fixed to the body section and a free end making contact with the body section and having elasticity.

### BRIEF DESCRIPTION OF THE DRAWINGS

FIG. 1 is a sectional view representing a conventional compressor and a bracket for fixing the compressor;

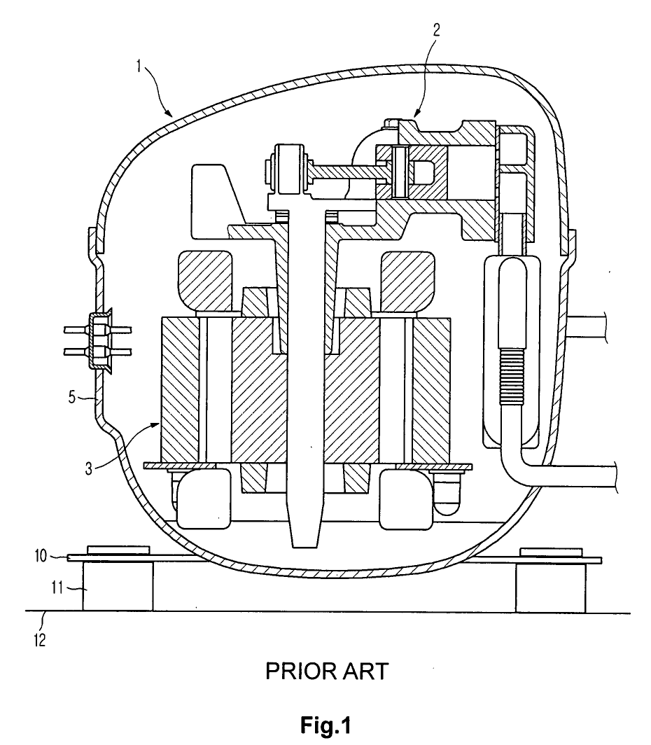

FIGS. 2 and 3 are perspective views representing a bracket according to a first embodiment of the present disclosure;

FIGS. 4 and 5 are perspective views representing a bracket according to a second embodiment of the present disclosure;

FIGS. 6 and 7 are perspective views representing a bracket according to a third embodiment of the present disclosure; and

FIGS. 8 and 9 are perspective and sectional views representing a bracket according to the fourth embodiment of the present disclosure, respectively.

### DETAILED DESCRIPTION OF THE PREFERRED EMBODIMENTS

Hereinafter, a bracket for fixing a compressor according to a preferred embodiment of the present disclosure will be explained in detail with reference to the accompanying drawings.

The compressor, the vibration-resistant member and the base described below are identical to those of the prior art, so the same reference numerals will be assigned to them and detailed description thereof will be omitted.

Hereinafter, the bracket for fixing the compressor according to the present disclosure will be explained.

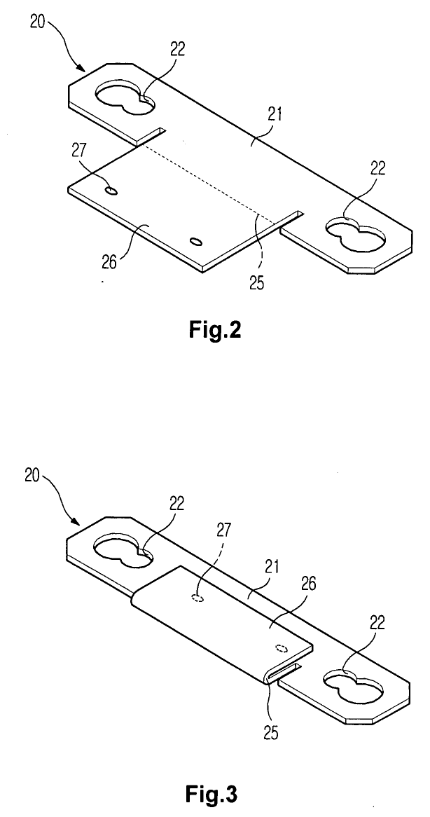

FIGS. 2 and 3 are perspective views representing the bracket 20 for fixing the compressor 1 according to a first embodiment of the present disclosure. As shown in FIG. 2, the bracket 20 for fixing the compressor 1 according to the first embodiment of the present disclosure includes a body section 21 which extends in one direction and a folding section 26 which extends from the center portion of the body section 21 in a width direction of the body section 21, so that the bracket 20 is formed in a T-shape as a whole.

Coupling holes 22, into which vibration-resistant members 11 are inserted, are formed at both sides of the body section 21 and a plurality of embosses 27, which protrude from a surface forming the folding section 26, are formed on the folding section 26. A bending section 25, which allows the folding section 26 to be bent, is formed at a boundary between the folding section 26 and the body section 21.

Such a bracket 20 having the above shape can be simply fabricated through a pressing process.

The folding section 26 of the bracket 20 is bent about the bending section 25 by 180° and the embosses 27, which make contact with the body section 21, are spot-welded, so that the body section 21 and the folding section 26 are coupled. Therefore, as shown in FIG. 3, a middle portion of the bracket 20 becomes thick, improving rigidity of the bracket 20.

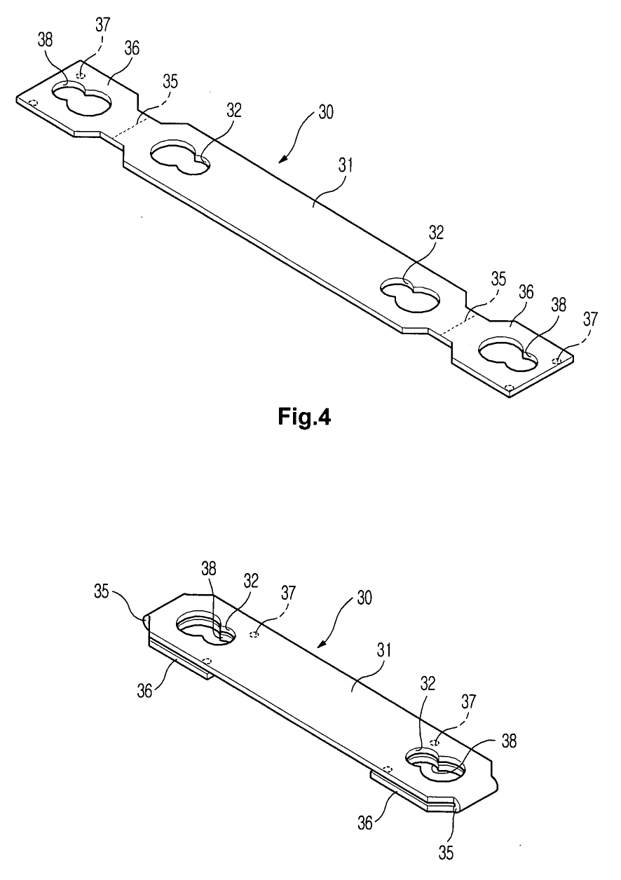

FIGS. 4 and 5 are views representing a bracket according to a second embodiment of the present disclosure. As shown in FIG. 4, the bracket 30 for fixing the compressor includes a body section 31 which extends in one direction and folding sections 36 which protrude from both sides of the body section 31 lengthwise along the body section 31.

Bending sections 35, which allow the folding sections 36 to be bent, are formed at boundary areas between the folding sections 36 and the body section 31.

First coupling holes 32, into which vibration-resistant members 11 are inserted, are formed at both sides of the body section 31 and a plurality of embosses 37, which protrude from a surface forming the folding sections 36, are formed on the folding sections 36. In addition, the body section 31 is formed with second coupling holes 38, which are formed symmetrically to the first coupling holes 32 about the bending sections 35 so as to form coupling holes together with the first coupling holes 32 when the folding sections 36 are folded by 180° so as to be coupled with the body section 31.

The folding sections 36 of the bracket 20 are folded about the bending sections 35 by 180° and the embosses 37, which make contact with the body section 31, are spot-welded so as to couple the folding sections 36 with the body section 31. Thus, as shown in FIG. 5, both sides of the bracket 30 become thick, improving rigidity of the bracket 30.

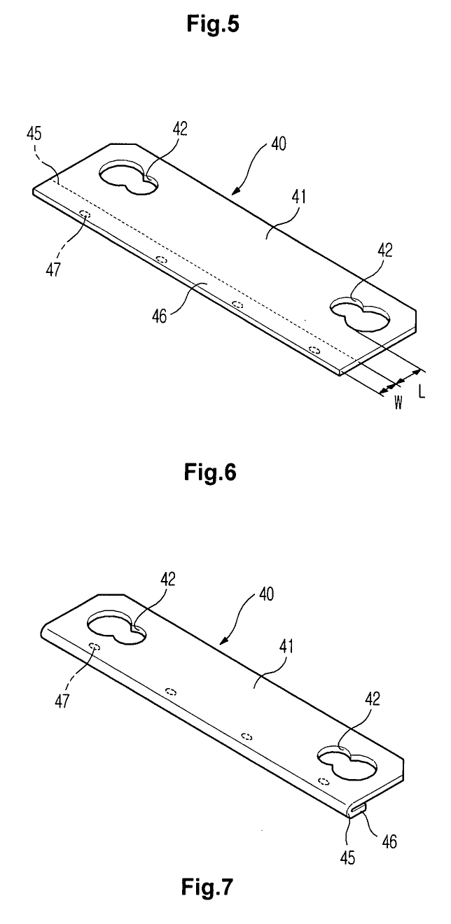

FIGS. 6 and 7 are views representing a bracket according to a third embodiment of the present disclosure. The bracket 40 for fixing the compressor 1 includes a body section 41 extending in one direction and a folding section 46 protruding in a width direction of the body section 41, while having a length identical to a length of the body section 41.

Coupling holes 42, into which vibration-resistant members 11 are inserted, are formed at both sides of the body section 41 and a plurality of embosses 47, which protrude from a surface forming the folding section 46, are formed on the folding section 46.

The folding section 46 preferably has a width smaller than a distance between the bending section 45 and coupling holes 42, so that the folding section 46 does not block the coupling holes 42, when the folding section 46 is rotated about the bending section 45 by 180° so as to be coupled with the body section 41.

The folding section 46 of the bracket 40 is bent about the bending section 45 by 180° and the embosses 47, which make contact with the body section 41, are spot-welded so as to couple the body section 41 with the folding section 46. Therefore, as shown in FIG. 7, a front portion and a rear portion of the bracket 40 have superior rigidity.

Hereinafter, an operation of reducing vibration generated from the compressor 1 fixed to the brackets 20, 30 and 40 according to the first to third embodiments will be explained.

When vibration of the compressor 1 is transferred to the bracket, if a natural frequency of the bracket corresponds to f, the natural frequency f is represented as below:

$$f = \frac{1}{2 π} \sqrt{\frac{k}{m}}$$

Here, k and m represent rigidity of the bracket and the mass of the bracket, respectively.

The above equation shows that if the mass m of the bracket increases, the natural frequency f decreases and if the rigidity k of the bracket increases, the natural frequency f increases.

According to the first to third embodiments, the mass m and the rigidity k of the bracket are increased by forming the folding section. However, if the increase rate of the rigidity k of the bracket is greater than that of the mass m, or the increase rate of the mass m of the bracket is greater larger than that of the rigidity k due to the folding section coupled to the body section, the natural frequency k of the bracket is changed.

If the natural frequency f of the bracket is changed, resonance phenomenon that occurs when a specific frequency generated from the compressor matches with the natural frequency of the bracket can be prevented.

Hereinafter, a bracket for fixing a compressor according to a fourth embodiment will be explained.

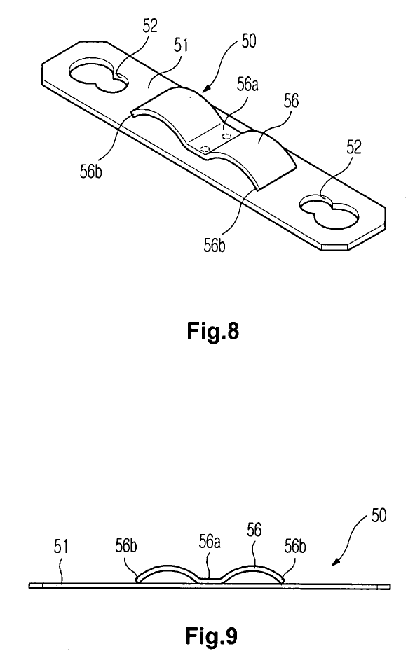

FIG. 8 is a view representing the bracket for fixing the compressor according to the fourth embodiment. The bracket 50 for fixing the compressor 1 according to the fourth embodiment of the present disclosure includes a body section 51 30 extending in one direction and a weight 56 coupled to a middle portion of the body section 51. At both sides of the body section 51, coupling holes 52 are formed and vibration-resistant members are inserted into the coupling holes 52.

The weight 56 is prepared in the form of a leaf spring having a corrugated shape and includes a fixing end 56a fixed to the bracket 50 by means of a spot-welding, and a free end 56b making contact with the body section 51 and having an elastic characteristic.

As described above, when vibration of the compressor 1 is transferred to the bracket 50, if a natural frequency of the bracket 50 corresponds to f, the natural frequency f is represented as below:

$$f = \frac{1}{2 π} \sqrt{\frac{k}{m}}$$

Here, k and m correspond to the rigidity of the bracket 50 and the mass of the bracket 50, respectively.

Since the above weight 56 is attached to the body section 51, the mass m of the bracket 50 increases. In addition, the fixing end 56a of the weight 56 is only fixed to the bracket 50 and the free end 56b having the elastic characteristic makes contact with the bracket 50, so that the rigidity k of the bracket 50 increases. In this case, if the increase rate of the mass m is similar to the increase rate of the rigidity k, the natural frequency f is rarely changed. However, since the free end 56b having the elastic characteristic makes contact with the body section 51, the displacement is reduced when the bracket 50 vibrates due to the resonance phenomenon.

Accordingly, although the variation of the natural frequency f of the bracket 50 is not great, vibration caused by resonance phenomenon occurring when the specific frequency of the compressor 1 matches with the natural frequency f of the bracket 50 can be reduced by restricting the displacement of the bracket 50.

As described above, the bracket for fixing the compressor according to the present disclosure can reduce vibration, which is generated due to resonance phenomenon occurring when the specific frequency of the compressor matches with the natural frequency of the bracket, by changing the natural frequency of the bracket or reducing the displacement during the vibration of the bracket.

What is claimed is:

1. A bracket for fixing a compressor, the bracket comprising:
a body section extending in one direction; and
a folding section coupled to the body section while being bent relative to the body section so as to change a natural frequency of the bracket.

2. The bracket as claimed in claim 1, wherein the folding section includes a plurality of embosses protruding from a flat surface forming the folding section, and the embosses are welded such that the body section is coupled with the folding section.

3. The bracket as claimed in claim 1, wherein the folding section protrudes from a middle portion of the body section in a width direction of the body section so as to be folded on the middle portion of the body section.

4. The bracket as claimed in claim 1, wherein the folding section protrudes from both sides of the body section in a length direction of the body section so as to be folded on both sides of the body section.

5. The bracket as claimed in claim 4, wherein the body section is formed with a first coupling hole, into which a vibration-resistant member supporting the bracket is coupled, and the folding section is formed with a second coupling hole, which is symmetrical to the first coupling hole about a bending section at which the folding section is bent.

6. The bracket as claimed in claim 1, wherein the folding section has a length identical to a length of the body section and protrudes in a width direction of the body section so as to be folded on the body section.

7. The bracket as claimed in claim 6, wherein the body section is formed with a coupling hole into which a vibration-resistant member supporting the bracket is coupled, and a width of the folding section is smaller than a distance between the bending section at which the folding section is bent and the coupling hole so as to prevent the folding section from blocking the coupling hole.

8. A bracket for supporting a compressor, the bracket comprising:
a body section extending in one direction; and
a weight coupled to the body section so as to reduce displacement when the bracket vibrates.

9. The bracket as claimed in claim 8, wherein the weight includes a leaf spring having a corrugated shape.

10. The bracket as claimed in claim 9, wherein the weight includes a fixing end fixed to the body section and a free end making contact with the body section and having elasticity.
